(19) United States
(12) Patent Application Publication
(10) Pub. No.: US 2007/0204185 A1
(43) Pub. Date: Aug. 30, 2007

(54) Data fetch circuit and control method thereof

(75) Inventor: Kiyonori Ogura, Kasugai (JP)

Correspondence Address: ARENT FOX PLLC, 1050 CONNECTICUT AVENUE, N.W., SUITE 400, WASHINGTON, DC, 20036, US

(73) Assignee: FUJITSU LIMITED

(21) Appl. No.: 11/445,144

(22) Filed: Jun. 2, 2006

(30) Foreign Application Priority Data
Feb. 28, 2006 (JP) 2006-052909

(51) Int. Cl. G06F 1/00

(52) U.S. Cl. 713/500

(57) ABSTRACT

To provide a data fetch circuit, which reliably cuts off transmission of a high impedance state of a data strobe signal even if a manufacture condition or an operation condition is changed, and a control method thereof. The data fetch circuit includes an RL measuring part 10 for measuring a latency measurement value RLB from an input of a read instruction signal RD to a valid edge of a data strobe signal DQS and an RL count comparing part 30 for outputting a BL count start signal BST for giving an instruction of a cancel of the cut-off of the data strobe signal DQS after standing by during the time based on the latency measurement value RLB in accordance with an input of a delay read instruction signal RDD.

### CROSS-REFERENCE TO RELATED APPLICATIONS

This application is based upon and claims the benefit of priority from the prior Japanese Patent Application No. 2006-52909 filed on Feb. 28, 2006, the entire contents of which are incorporated herein by reference.

### BACKGROUND OF THE INVENTION

1. Field of the Invention

The present invention relates to a technology for eliminating a high impedance state from a data strobe signal DQS outputted synchronously with a data signal DQ in a DDR SDRAM, and for generating a strobe signal for fetching the data signal DQ.

2. Description of the Related Art

In read-operation of the DDR SDRAM (Double Data Rate Synchronous Dynamic Random Access Memory), data is outputted to a memory bus from the SDRAM synchronously with an edge of the data strobe signal DQS. At this time, the data strobe signal DQS having three values makes a transition from the high impedance state to a low level or high level. Meanwhile, a device for reading data fetches the data outputted to the memory bus synchronously with the edge of the data strobe signal DQS. Further, when the data is actually fetched by the device, an internal data strobe signal is used that the high impedance of the data strobe signal is masked from the data strobe signal. The level of the data strobe signal in the high impedance state becomes unstable and therefore a noise is easily mixed to the data strobe signal. That is why there is a risk that an erroneous fetch arises when the data strobe signal in such a state is used for a clock of data fetch.

An SDRAM interface circuit 100 shown in FIG. 6 is used as a technology for masking the high impedance state from the data strobe signal DQS.

The SDRAM interface circuit 100 includes: an RL count comparing part 101 to which a read instruction signal RC, a standby clock number RL and a clock signal CK are inputted and which outputs a BL count start signal BST; a BL count comparing part 102 to which the BL count start signal BST, a burst length BL and a fetch data strobe signal IDQS is inputted and which outputs a mask signal XMASK; and an AND gate 103 to which the mask signal XMASK and the data strobe signal DQS is inputted and which outputs the fetch data strobe signal IDQS.

The RL count comparing part 101 starts counting the clock signals CK when the read instruction signal RC is inputted thereto, and outputs the BL count start signal BST when the count value reaches the standby clock number RL. Here, a value of the standby clock number RL is set in advance.

When the BL count start signal BST is inputted to the BL count comparing part 102, the BL count comparing part 102 makes the mask signal XMASK non-active, starts counting the clock signals CK and holds an active state of the mask signal XMASK until the count value reaches the burst length BL.

According to the above-described constitution, the SDRAM interface 100 starts counting the clock signals CK when the read instruction signal RC is inputted thereto, and makes the mask signal XMASK active by the number of clocks of the burst length BL when the count value reaches the standby clock number RL. The standby clock number RL is set in advance so that the data strobe signal DQS exceeds a period of the high impedance state. The high impedance of the data strobe signal DQS is thus masked, so an input of the data at the high impedance state to the fetch clock can be prevented.

Moreover, an art related to an SDRAM interface circuit is disclosed in Japanese unexamined patent publication No. 2003-85974.

### SUMMARY OF THE INVENTION

However, when a manufacture condition such as a process unevenness or an operation condition such as temperature or voltage is changed and a delay time between an SDRAM and an SDRAM interface circuit 100 becomes large, there arises a risk that a high impedance state of a data strobe signal DQS exceeds a period of a standby clock number RL. In such a case, a mask period of the high impedance of the data strobe signal DQS becomes insufficient, so there arises a problem that the high impedance is inputted to a fetch clock of the data.

In view of the above problem of the background art, the present invention was made, and it is an object of the present invention to provide a data fetch circuit, which reliably cuts off transmission of the high impedance state of the data strobe signal even if the manufacture condition or the operation condition is changed, and a control method thereof.

To achieve the above object, according to a first aspect of the invention, there is provided a data fetch circuit that masks an input of an invalid data strobe signal when it fetches a data signal synchronously with the data strobe signal inputted from the outside with the data signal in accordance with a read instruction signal inputted from the outside, comprising: a response time measuring part for measuring a response time from the input of the read instruction signal to a valid edge of the data strobe signal; and a standby part for giving an instruction of a cancel of the mask of the data strobe signal after standing by during the time based on the response time in accordance with a standby start signal based on the read instruction signal.

According to another aspect of the invention, there is provided a control method of a data fetch circuit that masks an input of an invalid data strobe signal when it fetches a data signal synchronously with a data strobe signal inputted from the outside with the data signal in accordance with a read instruction signal inputted from the outside, comprising the steps of: measuring a response time from the input of the read instruction signal to a valid edge of the data strobe signal; and giving an instruction of a cancel of the mask of the data strobe signal after standing by during the time based on the response time based on the read instruction signal.

In the data fetch circuit of the present invention, a response time from an input of a read instruction signal to a valid edge of the data strobe signal is measured, and the response time is set to a time of standby (also referred to as standby time hereinafter) of a standby part. That is, even if the manufacture condition such as a process or the operation condition such as time or voltage is changed and the delay time of the read instruction signal becomes uneven, the standby time is set based on the measured response time. Thus, the data fetch circuit can be realized which is capable of reliably masking the transmission of the high impedance of the data strobe signal without an impact on the manufacture condition or the operation condition.

The above and further objects and novel features of the invention will more fully appear from the following detailed description when the same is read in connection with the accompanying drawing it is to be understood, however, that the drawings are form the purpose of illustration only and are not intended as a definition of the limits of the invention.

### BRIEF DESCRIPTION OF THE DRAWINGS

FIG. 1 is a block diagram showing the structure of an SDRAM interface circuit according to a first embodiment;

FIG. 2 is a circuit diagram showing a specific example of the SDRAM interface circuit;

FIG. 3 is a circuit diagram showing an example of a transition detecting part;

FIG. 4 is a timing chart showing operation of the SDRAM interface circuit according to the first embodiment;

FIG. 5 is a block diagram showing the structure of an SDRAM interface circuit according to a second embodiment; and

FIG. 6 is a block diagram showing the structure of an SDRAM interface circuit of a prior art.

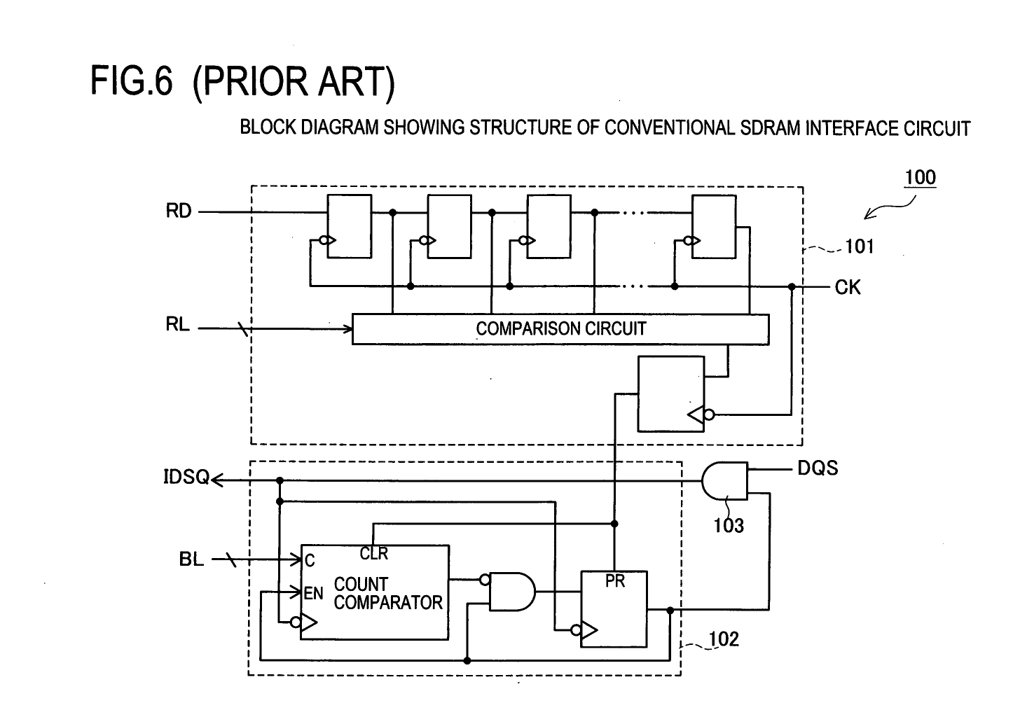

### DETAILED DESCRIPTION OF THE PREFERRED EMBODIMENTS

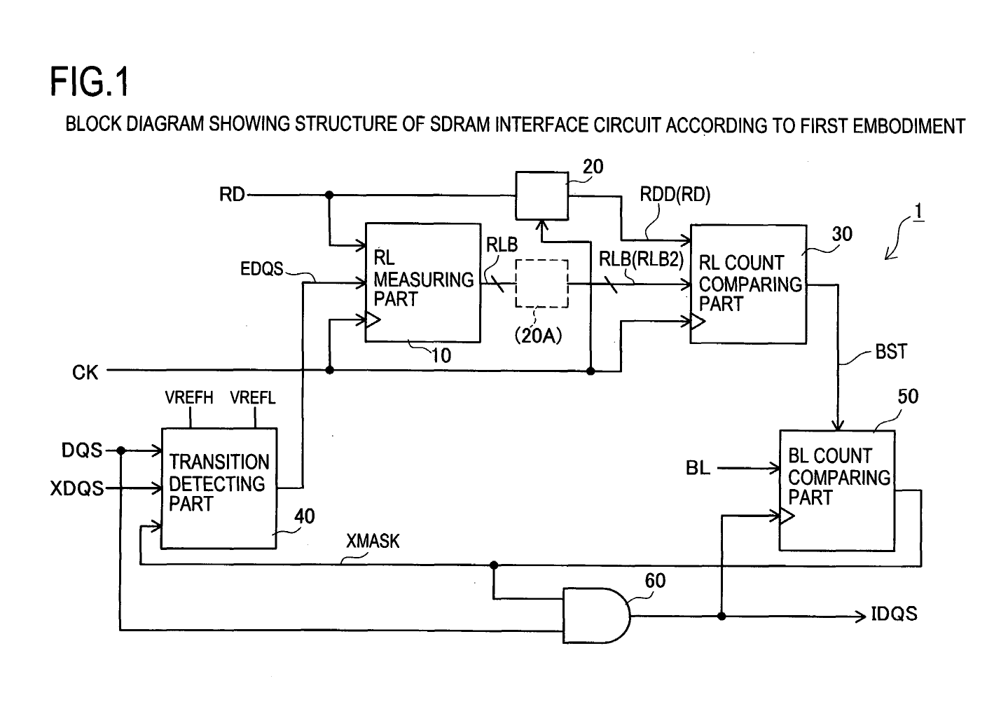

Hereinafter, embodiments which effectuate a data fetch circuit for carrying out the present invention will be described in detail with reference to FIG. 1 to FIG. 5.

FIG. 1 is a block diagram showing the structure of an SDRAM interface circuit 1 according to a first embodiment. The SDRAM interface circuit 1 is a part of a circuit for fetching a data signal DQ outputted synchronously with a data strobe signal DQS taking a three state condition, and is a circuit for generating a fetch data strobe signal IDQS that a high impedance state of the data strobe signal DQS is eliminated.

The SDRAM interface circuit 1 includes: an RL measuring part 10 to which a read instruction signal RD, the data strobe signal DQS and a clock signal CK are inputted and which outputs a latency measurement value RLB; and a delay part 20 to which the read instruction signal RD is inputted and which outputs a delay read instruction signal RDD.

Further, the SDRAM interface circuit 1 includes: an RL count comparing part 30 to which the delay read instruction signal RDD, the latency measurement value RLB and the clock signal CK are inputted and which outputs a BL count start signal BST; and a transition detecting part 40 to which the data strobe signal DQS, an inversion data strobe signal XDQS complementary to the data strobe signal DQS and an inversion mask signal XMASK are inputted and which outputs an internal data strobe signal EDQS.

Furthermore, the SDRAM interface circuit 1 includes: a BL count comparing part 50 to which the BL count start signal BST, a burst length BL and the fetch data strobe signal IDQS are inputted and which outputs the inversion mask signal XMASK; and a gate circuit 60 to which the inversion mask signal XMASK and the data strobe signal DQS are inputted and which outputs the fetch data strobe signal IDQS.

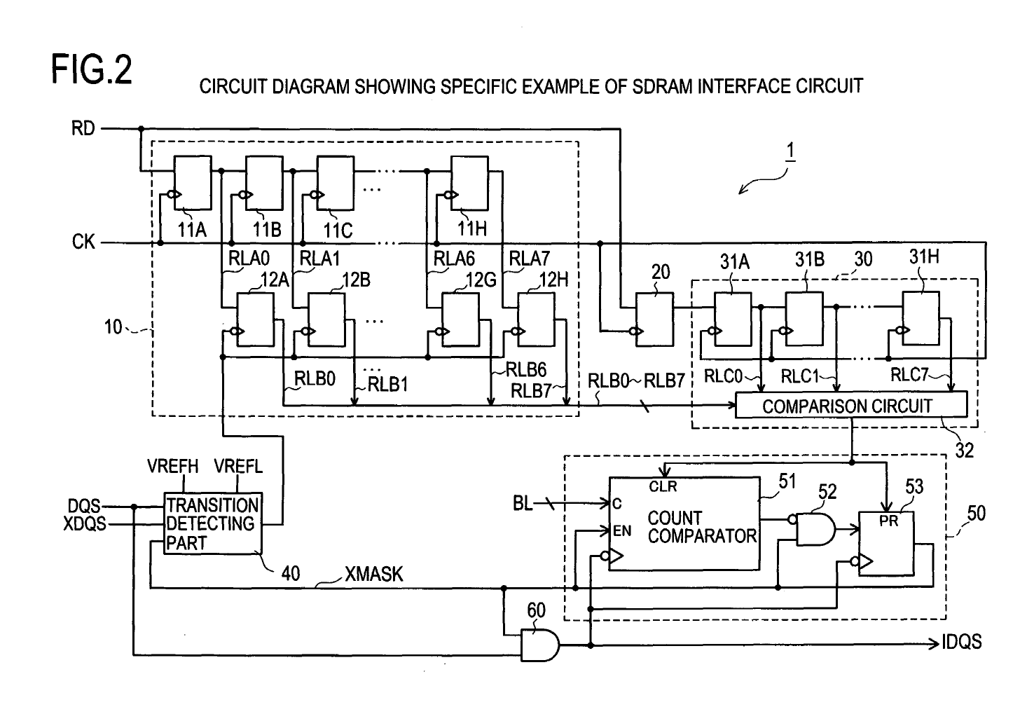

FIG. 2 is a circuit diagram showing a specific example of the SDRAM interface circuit 1. The RL measuring part 10 includes flip-flops 1A to 11H and 12A to 12H of which inversion clock terminals are respectively connected to the clock signal CK. The flip-flops 11A to 11H constitute a shift register of which a serial input terminal is a data input terminal of the flip-flop 11A. Additionally, the flip-flops 12A to 12H constitute a register for holding latency count values RLA 0 to 7, as the respective outputs of the flip-flops 11A to 11H, in accordance with the internal data strobe signal EDQS. Each output terminal of the flip-flops 12A to 12H is connected to the RL count comparing part 30 as the latency measurement values RLB 0 to 7.

The delay part 20 is constituted by a flip-flop of which an inversion clock terminal is connected to the clock signal CK and a data input terminal is connected to the read instruction signal RD. Thus, in the delay part 20, the read instruction signal RD is delayed by one period of the clock signal CK and the delay read instruction signal RDD is outputted at first.

The RL count comparing part 30 includes: flip-flops 31A to 31H that the clock signal CK is connected to each of clock input terminals thereof; and a comparison circuit 32 for selecting any of RL count values RLC 0 to 7 outputted from the flip-flops 31A to 31H in accordance with the latency measurement values RLB 0 to 7. The flip-flops 31A to 31H constitute a shift register of which a serial input terminal is a data input terminal of the flip-flop 31A. When the delay read instruction signal RDD is inputted to the data input terminal of the flip-flop 31A, the RL count values RLC are shifted up in order. When the RL count value RLC reaches the latency measurement value RLB, the BL count start signal BST makes a transition to a high level.

The transition detecting part 40 compares the data strobe signal DQS and the inversion data strobe signal XDQS, which are complementary to each other, with a high level threshold voltage VREFH and a low level threshold voltage VREFL. Thus, a transition of the data strobe signal DQS from the high impedance to a low level is detected, and the internal data strobe signal EDQS is outputted.

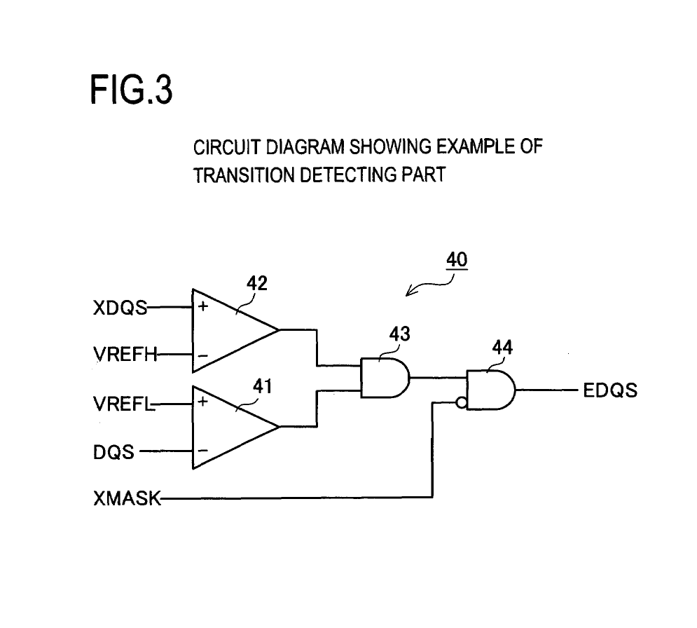

FIG. 3 is a circuit diagram showing an example of the transition detecting part 40. The transition detecting part 40 includes a first comparator 41, a second comparator 42 and gate circuits 43 and 44. In the first comparator 41, a non-inversion input terminal is connected to the low level threshold voltage VREFL, an inversion input terminal is connected to the data strobe signal DQS and an output terminal is connected to an input terminal of the gate circuit 43, respectively. In the second comparator 42, a non-inversion input terminal is connected to the inversion data strobe signal XDQS, an inversion input terminal is connected to the high level threshold voltage VREFH and an output terminal is connected to another input terminal of the gate circuit 43. In the gate circuit 44, an input terminal is connected to an output terminal of the gate circuit 43, another negative logic input terminal is connected to the inversion mask signal XMASK and an output terminal is connected to the internal data strobe signal EDQS.

The level of the data strobe signal DQS is complementary to that of the inversion data strobe signal XDQS. That is, the level of the inversion data strobe signal XDQS is low when the level of the data strobe signal DQS is high, and the level of the inversion data strobe signal XDQS is high when the level of the data strobe signal DQS is low. However, both the data strobe signal DQS and the inversion data strobe signal XDQS become the high impedance state, the signals are respectively set to middle voltages between high level and low level by a termination resistor (not shown) connected to the outside. Since the termination resistor functions to either signal in the same way, the respective signals take an approximate same potential in the case of being in the high impedance state.

Additionally, the high level threshold voltage VREFH is a threshold voltage for detecting a high level, and the low level threshold voltage VREFL is a threshold voltage for detecting a low level, to the data strobe signal DQS and the inversion data strobe signal XDQS.

When the level of the data strobe signal DQS is high and the level of the inversion data strobe signal XDQS is low, the first comparator 41 outputs a high level since the voltage of the data strobe signal DQS is lower than the low level threshold voltage VREFL, and the second comparator 42 outputs a high level since the voltage of the inversion data strobe signal XDQS is higher than the high level threshold voltage VREFH. Thus, the gate circuit 43 outputs a high level.

Next, when the level of the data strobe signal DQS is low and the level of the inversion data strobe signal XDQS is high, the first comparator 41 outputs a low level since the voltage of the data strobe signal DQS is higher than the low level threshold voltage VREFL, and the second comparator 42 outputs a low level since the voltage of the inversion data strobe signal XDQS is lower than the high level threshold voltage VREFH. Thus, the gate circuit 43 outputs a low level.

Finally, when both the data strobe signal DQS and the inversion data strobe signal XDQS are in the high impedance state, at least either of the first comparator 41 or the second comparator 42 outputs the low level since each potential of the signals becomes the same. Thus, the gate circuit 43 outputs the low level.

Thus, since the gate circuit 43 outputs the low level when the data strobe signal DQS is in the high impedance state and the level thereof is low, the low level is outputted to the internal data strobe signal EDQS. Additionally, since the gate circuit 43 outputs the high level when the level of the data strobe signal DQS is high, the high level is outputted to the internal data strobe signal EDQS for the period when the level of the inversion mask signal XMASK is low.

The BL count comparing part 50 will be described with reference to FIG. 2. The BL count comparing part 50 includes: a count comparator 51 in which the burst length BL is connected to a comparison input terminal C, the inversion mask signal XMASK is connected to a count enable terminal EN, and the fetch data strobe signal IDQS is connected to a clock terminal; a gate circuit 52 in which an output of the count comparator 51 is connected to an inversion side input terminal, and the inversion mask signal XMASK is connected to a non-inversion side input terminal; and a flip-flop 53 of which a data input terminal is connected to an output of the gate circuit 52 and a clock terminal is connected to the fetch data strobe signal IDQS. Here, the data strobe signal IDQS is a signal that a gate circuit 60 takes an AND operation of the inversion mask signal XMASK and the data strobe signal DQS.

Moreover, the BL count start signal BST is connected to a clear terminal CLR of the count comparator 51 and a preset terminal PR of the flip-flop 53. Thus, when the level of the BL count start signal BST becomes high, the count comparator 51 is reset, the flip-flop 53 is preset, and the BL count comparator 50 is initialized.

The BL count comparator 50 outputs a high level to the inversion mask signal XMASK when initialized, and makes a count value of the count comparator 51 zero. Further, the count comparator 51 counts every falling edge of the fetch data strobe signal IDQS, and outputs a high level when the count value reaches the burst length BL. Then, a low level is outputted to the output of the gate circuit 52. Furthermore, the inversion mask signal XMASK, which is an output of the flip-flop 53, makes a transition to a low level in the falling edge of the fetch data strobe signal IDQS.

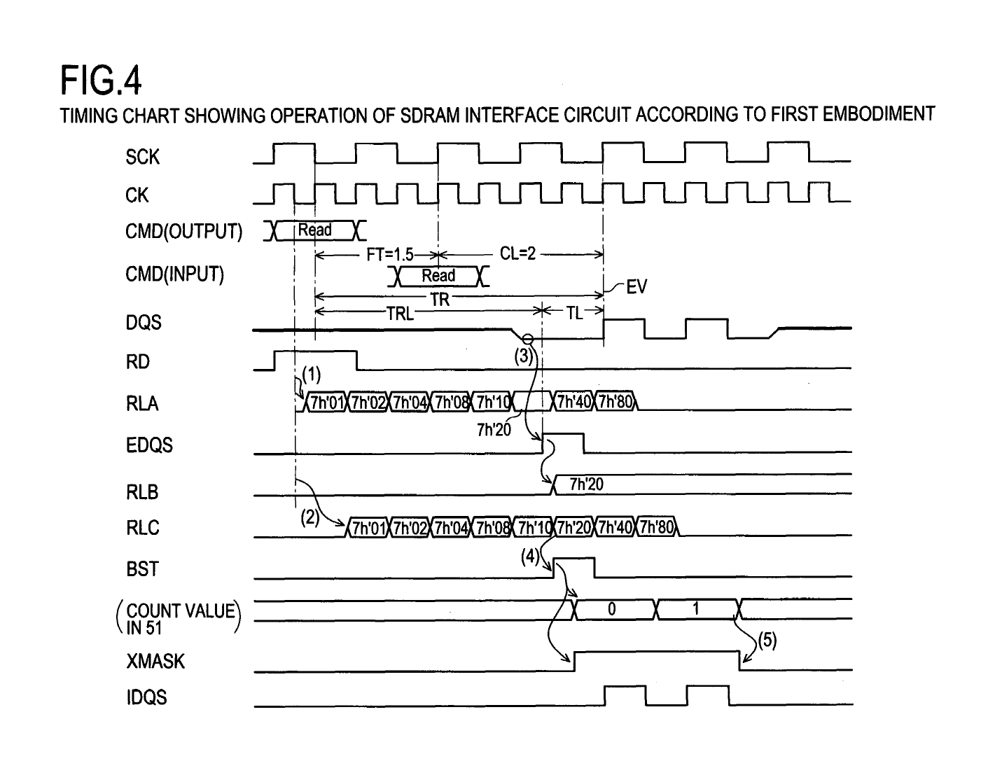

Next, operation of the SDRAM interface circuit 1 will be described. FIG. 4 is a timing chart showing the operation of the SDRAM interface circuit 1 according to the first embodiment.

Here, a system clock signal SCK is a clock in which an SDRAM (not shown) operates. The clock signal CK is a clock signal of the SDRAM interface circuit 1 having a double frequency of that of the system clock signal SCK. A command signal CMD is a signal that an SDRAM controller (not shown) instructs the SDRAM to operate. That is, the command signal CMD is issued from the SDRAM controller to the SDRAM. In FIG. 4, “CMD (OUTPUT)” indicates an output from the SDRAM controller and “CMD (INPUT)” indicates an input to the SDRAM. Additionally, “(COUNT VALUE IN 51)” indicates a count value of the inside of count comparator 51. The other symbols are symbols based on the signal names shown in FIG. 2 respectively.

Additionally, in FIG. 4, “FT” indicates a flight time FT and “CL” indicates a CAS latency CL. The flight time FT is the number of clocks of the system clock signal SCK when the command signal CMD is transmitted from the SDRAM controller to the SDRAM. In the present embodiment, the flight time FT is equal to 1.5 and the CAS latency CL is equal to 2. That is, the latency RL is equal to 3.5 which is the number of clocks from the issuance of a command signal CMD of Read (transition of the read instruction signal RD to a high level) to a valid edge EV of the data strobe signal DQS. That is, a response time TR from an input of the read instruction signal RD to the valid edge EV is represented by a period of 3.5× the system clock signal SCK.

In (1) of FIG. 4, when “Read” is issued to the command signal CMD and the read instruction signal RD makes the transition to a high level, the RL measuring part 10 starts counting the latency count values RLA. Also in (2), the RL measuring part 10 starts counting the RL count values RLC after delay by a LH transition time TL, that is, one cycle of the clock signal CK. Both the count values of the latency count value RLA and the RL count value RLC are counted by the shift register, thereby taking values shifted bit by bit from the least significant bit. That is, 01, 02, 04, 08, 10, 20, 40 and 80 is outputted in this order by an octal number in either count value.

In (3), when the data strobe signal DQS makes the transition from the high impedance to the low level, the transition detecting part 40 detects the state transition and outputs a high level to the internal data strobe signal EDQS. When the internal data strobe signal EDQS makes a transition to the high level, the RL measuring part 10 holds the value of the latency count value RLA and outputs 20 to the latency measurement value RLB. The value of the latency measurement value RLB is a value corresponding to a detection time TRL from the input of the read instruction signal RD to the transition of the data strobe signal DQS from the high impedance to the low level.

In (4), when the output value 20 of the latency measurement value RLB corresponds to an output value 20 of the RL count value RLC, the RL count comparing part 30 outputs a high level to the BL count start signal BST only for a period when the value of the RL count value RLC is 20. Moreover, the RL count comparing part 30 starts counting with advance delay by the LH transition time TL and stands by for the measured detection time TRL, thereby standing by for the response time TR and outputting the BL count start signal BST.

And then, when the BL count start signal BST makes the transition to the high level, the count value of the count comparator 51 is initialized as zero and a high level is outputted from the BL count comparing part 50 to the inversion mask signal XMASK. When the inversion mask signal XMASK makes the transition to the high level, the level of the data strobe signal DQS is transmitted via the gate circuit 60 and a strobe signal is outputted to the fetch data strobe signal IDQS.

In (5), when the count value of the count comparator 51 reaches the value set to the burst length BL (when the burst length=2, BL=1), a low level is outputted to the inversion mask signal XMASK by fall of the fetch data strobe signal IDQS. Thus, the gate circuit 60 cuts off the subsequent data strobe signals DQS.

Moreover, when a command signal CMD of Read is further issued to the SDRAM with Read-operation to the command signal CMD not completed, the Burst READ Interrupt by READ mode is performed. In this case, the data strobe signal DQS outputs a strobe signal to the second command signal CMD without making the transition to the high impedance. The RL count comparing part 30 starts counting the RL count values RLC from a point of time when a read instruction signal RD is issued to the second command signal CMD, and outputs a BL count start signal BST again at a point of time when the count value reaches 20. Thus, a latency to the second read instruction signal RD, FT=1.5+CL=2, is reflected on the inversion mask signal XMASK, and cut-off control of the data strobe signal DQS is accurately performed along an output timing of the strobe signal of the data strobe signal DQS.

In the SDRAM interface circuit 1 according to the first embodiment, the latency measurement value RLB in which the time from the input of the read instruction signal RD to the internal data strobe signal EDQS is measured is set as a standby time value in the RL count comparing part 30. Thus, even if the flight time FT is changed due to a change of a manufacture condition such as a process unevenness or an operation condition such as temperature or voltage are changed, the latency is adjusted in accordance with the change and the cut-off control of the data strobe signal can be performed. Accordingly, the SDRAM interface circuit 1 can reliably cut off the transmission at the high impedance state without an impact of the change of the flight time FT.

Moreover, the shift part 20A described below for shifting the latency measurement value RLB left and outputting a latency measurement value RLB2 may be provided in place of the delay part 20. Although the flip-flops 31A to 31H are shifted at the same timing as the flip-flops 11A to 11H, the latency measurement value RLB2 is shifted left, therefore the BL count start signal BST can be outputted at the same timing as the case where the delay part 20 is used.

Additionally, when the number of shift bits of the shift part 20A is fixed, a connection of the latency measurement value RLB from the RL measuring part 10 to RL count comparing part 30 is sufficient as long as allowing an arrangement of the bits to shift. Thus, a circuit structure more simple than the case where the delay part 20 is used can be obtained. Additionally, such a simple structure can be achieved even in a case where the delay time of the latency measurement value RLB is changed by using a barrel shifter, etc., for the shift part 20A.

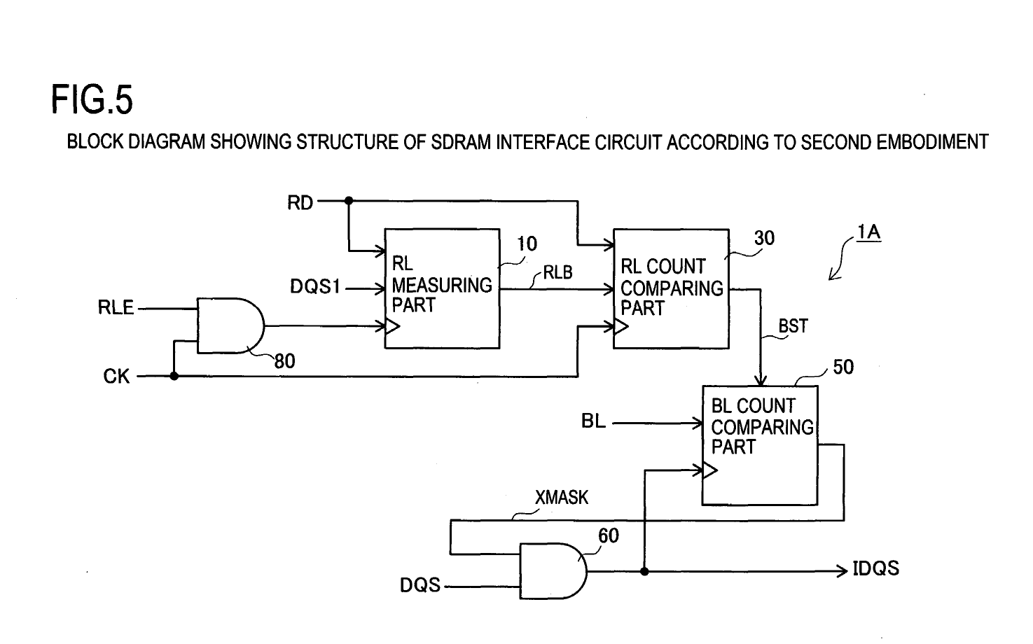

Next, an SDRAM interface circuit 1A according to a second embodiment will be described. FIG. 5 is a block diagram showing the structure of the SDRAM interface circuit 1A. The SDRAM interface circuit 1A is different from the SDRAM interface circuit 1 according to the first embodiment that the SDRAM interface circuit 1 includes a gate circuit 80 to which a measurement instruction signal RLE and the clock signal CK are inputted and which outputs to the clock terminal of the RL measuring part 10, and is the same as the SDRAM interface circuit 1 regarding the other components. Accordingly, the different part from the SDRAM interface circuit 1 according to the first embodiment will be mainly described, and descriptions of the other parts will be simplified or omitted.

A first data strobe signal DQS1 indicating a first rising edge after the transition of the data strobe signal DQS from the high impedance to the low level is inputted to the RL measuring part 10. Moreover, the first data strobe signal DQS1 can be generated in such a way that the SDRAM interface circuit 1A includes the transition detecting part 40 similarly to the SDRAM interface circuit 1 according to the first embodiment and delays detecting the transition of the data strobe signal DQS from the high impedance to the low level.

The gate circuit 80 calculates an AND operation of the measurement instruction signal RLE which is inputted to an input terminal of the gate circuit 80 and the clock signal CK which is inputted to the other input terminal thereof, and outputs the results to the clock terminal of the RL measuring part 10. Thus, in the RL measuring part 10, the latency measurement value RLB is updated only for a period that the level of the measurement instruction signal RLE is high. Operation after the setting of the latency measurement value RLB is similar to that of the SDRAM interface circuit 1 of the first embodiment.

Here, it is possible that the measurement instruction signal RLE is controlled so as to make a transition to the high level for a specific period, for example, at a power-on time or an initial setting of a system so that a count or update operation for obtaining the latency measurement value RLB, etc., is not performed for every transition of the data strobe signal DQS from the high impedance to the low level. Thus, operation power consumed for the count or update operation for obtaining the latency measurement value RLB can be reduced, and further consumption power of the entire SDRAM interface circuit 1A can be reduced.

Moreover, it is obvious that the present invention is not limited to the above-described embodiments and various improvements or modifications are applicable without departing from the spirit of the present invention.

For example, although the shift register used for the RL measuring part 10 and the RL count comparing part 30 is employed as a counter in the first and second embodiments, a normal binary counter may be employed as a counter.

Moreover, the SDRAM interface circuit is an example of the data fetch circuit, the RL measuring part and the transition detecting part are examples of a response time measuring part. The RL count comparing part is an example of the standby part, the read instruction signal or the delay read instruction signal is an example of the standby start signal, the LH transition time is an example of a predetermined time, the RL measuring part is an example of the measuring part, and the delay part or the shift part is an example of a standby adjusting part. Additionally, the low level is an example of a first logic level, the high level is an example of a second logic level, the low level threshold voltage is an example of a first threshold voltage, and the high level threshold voltage is an example of a second threshold voltage.

A data fetch circuit, which reliably masks transition of a high impedance state of a data strobe signal even if a manufacture condition or an operation condition is changed, and a control method thereof can be provided by application of the present invention.

What is claimed is:

1. A data fetch circuit that masks an input of an invalid data strobe signal when it fetches a data signal synchronously with the data strobe signal inputted from the outside with the data signal in accordance with a read instruction signal inputted from the outside, comprising:
a response time measuring part for measuring a response time from the input of the read instruction signal to a valid edge of the data strobe signal; and
a standby part for giving an instruction of a cancel of the mask of the data strobe signal after standing by during the time based on the response time in accordance with a standby start signal based on the read instruction signal.

2. The data fetch circuit according to claim 1, wherein the data strobe signal makes a transition from a high impedance to a first logic level in accordance with the read instruction signal and thereafter makes a transition to a second logic level through a predetermined time to output the valid edge; and
the response time measuring part comprises: a transition detecting part for detecting the transition of the data strobe signal from the high impedance to the first logic level; and a measuring part for measuring a detection time from the input of the read instruction signal to an output of a detection result of the transition detecting part; and
the data fetch circuit further comprises a standby adjusting part for adding the predetermined time to the detection time.

3. The data fetch circuit according to claim 2, wherein the standby adjusting part sets a value in which the predetermined time is added to the detection time as the standby time of the standby part.

4. The data fetch circuit according to claim 2, wherein the standby adjusting part delays the read instruction signal by the predetermined time and inputs the delayed read instruction signal as the standby start signal of the standby part.

5. The data fetch circuit according to claim 2, wherein the transition detecting part comprises: a first comparator in which the strobe input signal is inputted to an inversion input terminal and a first threshold voltage for detecting the first logic level is inputted to a non-inversion input terminal; a second comparator in which an inversion data strobe signal complementary to the data strobe signal is inputted to a non-inversion input terminal and a second threshold voltage for detecting the second logic level is inputted to an inversion input terminal; and a gate circuit that calculate an AND operation of outputs of the first and second comparators.

6. The data fetch circuit according to claim 1, wherein the response time measuring part makes measurement of the response time valid in accordance with a measurement instruction signal inputted from the outside.

7. The data fetch circuit according to claim 1, wherein the response time measuring part comprises: a counter part for starting counting clock signals in accordance with the input of the read instruction signal; and
a holding part for holding an output of the counter part in accordance with the valid edge of the data strobe signal.

8. The data fetch circuit according to claim 7, wherein the counter part includes a shift register to which the read instruction signal is inputted as a data input and the clock signal is inputted as a clock input.

9. A control method of a data fetch circuit that masks an input of an invalid data strobe signal when it fetches a data signal synchronously with a data strobe signal inputted from the outside with the data signal in accordance with a read instruction signal inputted from the outside, comprising the steps of:
measuring a response time from the input of the read instruction signal to a valid edge of the data strobe signal; and
giving an instruction of a cancel of the mask of the data strobe signal after standing by during the time based on the response time based on the read instruction signal.

10. The control method of a data fetch circuit according to claim 9, wherein
the data strobe signal makes a transition from a high impedance to a first logic level in accordance with the read instruction signal and thereafter makes a transition to a second logic level through a predetermined time to output the valid edge; and
the step of measuring the response time comprises the steps of:
detecting the transition of the data strobe signal from the high impedance to the first logic level; and
measuring a detection time from the input of the read instruction signal to an output of a detection result of the step of detecting the transition; and
adding the predetermined time to the detection time.

11. The control method of a data fetch circuit according to claim 9, wherein the step of counting the response time further comprises the step of making measurement of the response time valid in accordance with a measurement instruction signal inputted from the outside.

12. The control method of a data fetch circuit according to claim 9, wherein the step of measuring the response time comprises the steps of: starting counting clock signals in accordance with the input of the read instruction signal; and holding a count result of the step of starting the counting in accordance with the valid edge of the data strobe signal.
